(19) United States
(12) Patent Application Publication
(10) Pub. No.: US 2005/0002117 A1
(43) Pub. Date: Jan. 6, 2005

(54) Image-pick up lens

(76) Inventors: Noboru Ninomiya, Omne-shi (JP); Naohisa Yamaguchi, Hara-mura (JP); Eiki Matsuo, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/435,485

(22) Filed: May 9, 2003

(30) Foreign Application Priority Data
May 10, 2002 (JP) 2002-136255

(51) Int. Cl. G02B 13/18; G02B 3/02

(52) U.S. Cl. 359/719

(57) ABSTRACT

A low-cost bright image-pick up lens of a small size is provided which is short in total length, wherein around a 30° angle of field is enabled, the angle of incidence onto the image pickup device is narrowed, and various aberrations are appropriately corrected. The image-pick up lens comprises, from the side of an object, an aperture stop, a first meniscus lens having a convex surface on the side of an object, and a second meniscus lens with both surfaces being aspheric having a convex surface on the object side and when ‘f’ indicates the focal length of all the systems; ‘f2’ indicates the focal length of the second lens; ‘R2’ indicates the paraxial curvature radius of the first lens on the side of an image; and R3 indicates the paraxial curvature radius of the second lens on the object side, the conditions: 0.2<f/f2<2 and 0<R3/R2<0.9 are satisfied.

### BACKGROUND OF THE INVENTION

1. Technical Field of the Invention

The present invention relates to an image-pick up lens, which forms an image of an object onto an image-receiving surface.

2. Related Art

In recent years, camera modules for taking photos have begun to be incorporated in mobile terminals including mobile phones. Downsizing the camera modules is a prerequisite for these apparatuses in order to enhance their portability. In the meantime, regarding an image pickup device such as CCD and CMOS, a pixel having the size of approximately a few μm has become feasible, such that high-resolution and compact image pickup devices can be realized. Thus, there is much demand for cost reduction as well as downsizing of an image-pick up optical system to be incorporated to such image pickup devices. An optical system is expected to satisfy all requirements of compactness, low cost, high resolution and excellent optical performance, which could conflict with each other.

More specific requirements expected of the optical system may roughly be classified as follows:
Low cost (the system including as few lenses as possible; enabled to be formed of resin; and easily assembled)
Brightness (small Fno)
Compactness (particularly, the length from the lens edge to the image pickup device being short)
Wide angle of view (desirably, 30° or more)
Uniform illumination on image surface (few eclipses/narrowing down the angle of incidence onto an image pickup device)
High resolution (appropriately corrected fundamental aberration such as spherical aberration, coma aberration, curvature of field, astigmatism, distortion, and chromatic aberration)
If an optical system satisfying all the above requirements can be formed with few lenses, the range of applying the system will be broadened. Many kinds of lenses have been proposed so far; however, it has been very difficult to satisfy all the requirements by using only two lenses or so.

As for the two-lens structure, arranging “a negative lens” and “a positive lens” from the side of an object is advantageous in correcting aberrations, but the arrangement limits the size reduction. In order to shorten the overall length of the two-lens structure, it is desirable to arrange a pair of “a positive lens and a positive lens” or a pair of “a positive lens and a negative lens”. Moreover, in order to narrow down the angle of incidence onto the image pickup device, it is desirable to employ ‘front-set stop’ which has an aperture stop at the side closest to the object. Among structures having been proposed so far, Japanese patent unexamined application laid open No. 01-245211 and No. 04-211214 disclose structures satisfying the above requirements.

FIG. 19 shows a sectional view of the disclosure in the unexamined patent application laid open No. 01-245211. The structure is composed of a first biconvex positive lens and a second negative meniscus lens having a concave surface on the image side. In this example, the second lens exhibits relatively stronger power and has a concave surface on the side of an image, so that the angle of incidence onto the image pickup device is likely to be wide. Consequently, it is difficult to enlarge the angle of field, and the angle of field of the example is not beyond approximately 20°, which is relatively a small value.

FIG. 20 shows a sectional view of the disclosure in the unexamined patent application laid open No. 04-211214. The structure is composed of an image-pick up lens 10 on the side of an object and a correction lens 20 on the side of an image. In this example, the image-pick up lens 10 on the side of the object takes charge of power of almost all systems, and both surfaces of the correction lens 20 on the side of the image is aspheric. Consequently, field aberration is corrected so as to maintain balance among aberrations that occur when enlarging the angle of field. In this configuration, the lens 10 on the object side is in charge of the fundamental image-pick up functions. Therefore, when the lens on the object side is configured with a single lens, there is a limit in taking balance of field aberrations only by using the correction lens 20 while narrowing down the angle of incidence onto an image pickup device. Moreover, it is also difficult to correct chromatic aberration effectively, and thus widening the angle is limited.

The present invention provides a low-cost image-pick up lens system of a small size in which around a 30° angle of view is enabled, the total length is short, and various aberrations are appropriately corrected.

### SUMMARY

In order to achieve the above features, the present invention takes the following configurations. According to a first aspect, an image-pick up lens of the present invention comprises, from the side of an object, an aperture stop, a first meniscus lens having a convex surface on the object side, and a second meniscus lens having a convex surface on the object side. Then, when at least both surfaces of the second lens are aspheric, and ‘f’ indicates the focal length of all the systems, ‘f2’ indicates the focal length of the second lens, ‘R2’ indicates the paraxial curvature radius of the first lens on the side of an image, and ‘R3’ indicates the paraxial curvature radius of the second lens on the object side, the following conditions are satisfied:
0.2<f/f2<2
0<R3/R2<0.9

According to a second aspect, at least one surface of the first meniscus lens is aspheric in the image-pick up lens of the present invention.

According to a third aspect, when ‘f’ indicates the focal length, ‘T’ indicates the length from the aperture stop to an image surface, and ‘d2’ indicates the space between the first lens and the second lens, the image-pick up lens of the present invention satisfies the following conditions:
d2/f<0.4
T/f<2

A targeted image-pick up lens system can be provided by employing the above configurations.

### BRIEF DESCRIPTION OF THE DRAWINGS

FIG. 1 is an optical sectional view of the Example 1 showing an embodiment of an image-pick up lens.

FIG. 2 shows field aberrations of the Example 1.

FIG. 3 shows an optical section of the Example 2.

FIG. 4 shows field aberrations of the Example 2.

FIG. 5 shows an optical section of the Example 3.

FIG. 6 shows field aberrations of the Example 3.

FIG. 7 shows an optical section of the Example 4.

FIG. 8 shows field aberrations of the Example 4.

FIG. 9 shows an optical section of the Example 5.

FIG. 10 shows field aberrations of the Example 5.

FIG. 11 shows an optical section of the Example 6.

FIG. 12 shows field aberrations of the Example 6.

FIG. 13 shows an optical section of the Example 7.

FIG. 14 shows field aberrations of the Example 7.

FIG. 15 shows an optical section of the Example 8.

FIG. 16 shows field aberrations of the Example 8.

FIG. 17 shows an optical section of the Example 9.

FIG. 17 shows field aberrations of the Example 9.

FIG. 19 is a sectional view of the disclosure in unexamined patent application laid open No. ₀₁-_{245211.}

FIG. 20 is a sectional view of the disclosure in unexamined patent application laid open No. 24-211214.

### DETAILED DESCRIPTION

The following explains an embodiment of the present invention based on particular examples of configurations.

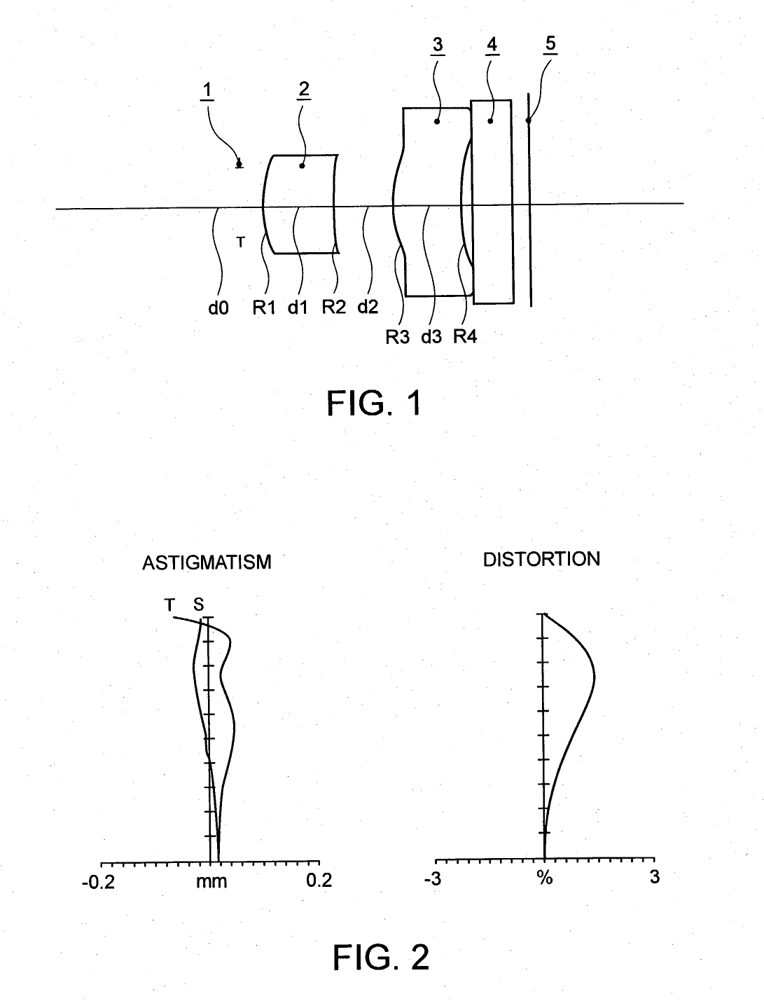

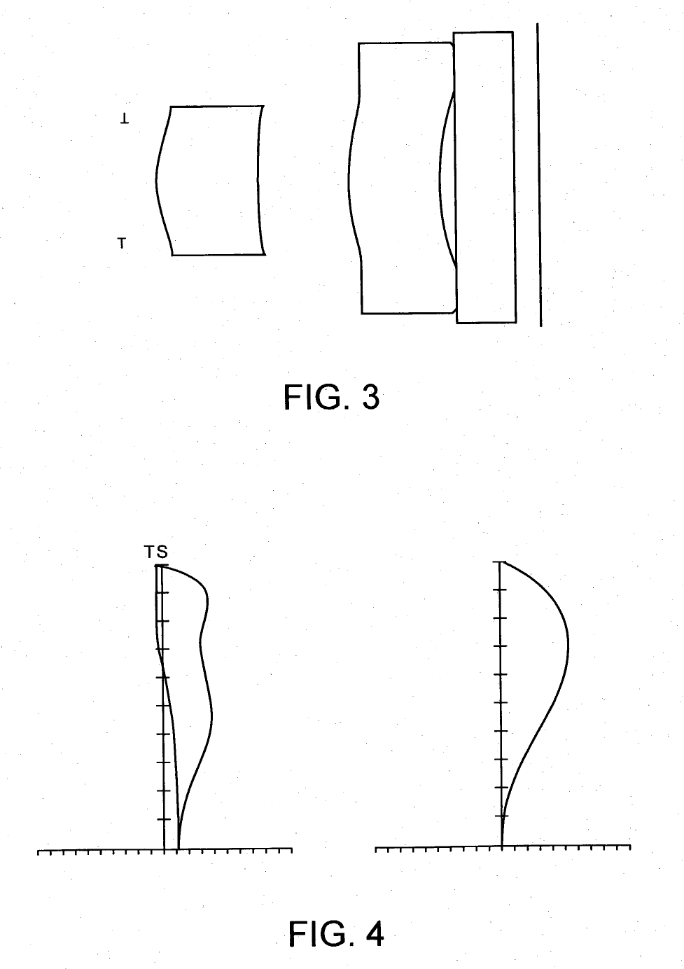

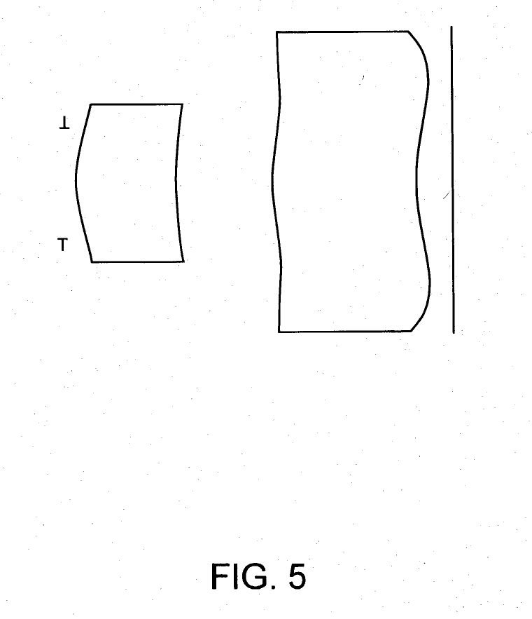

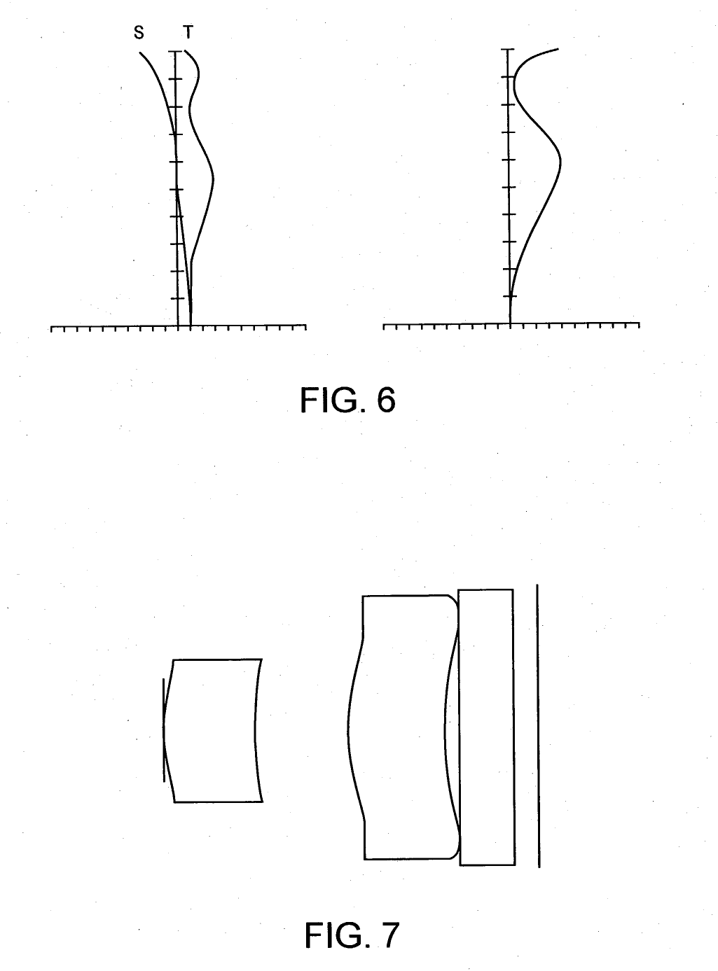

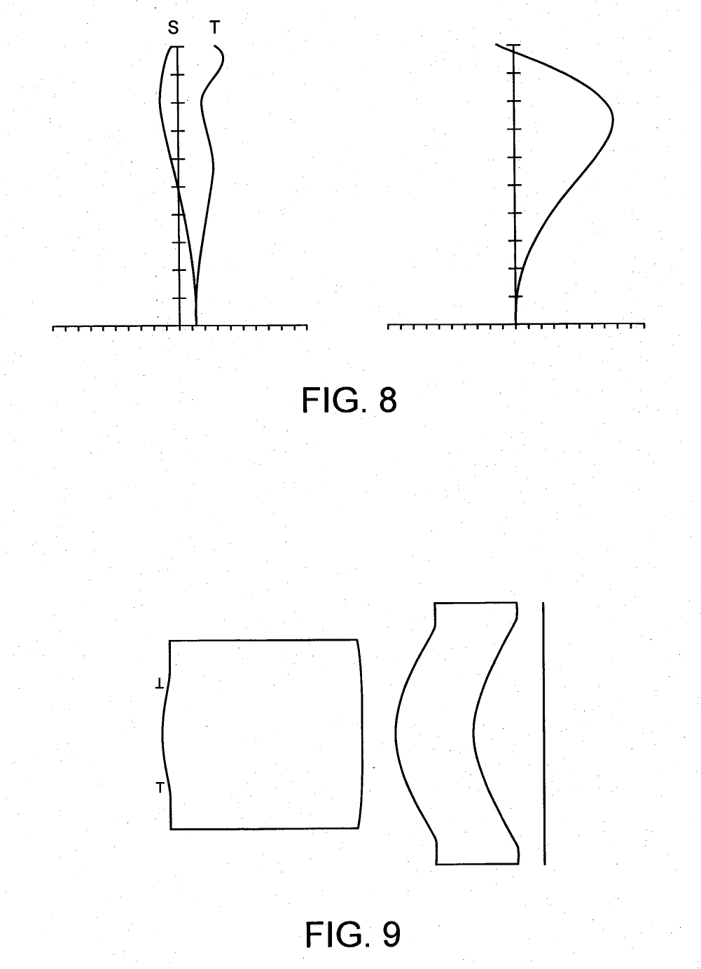

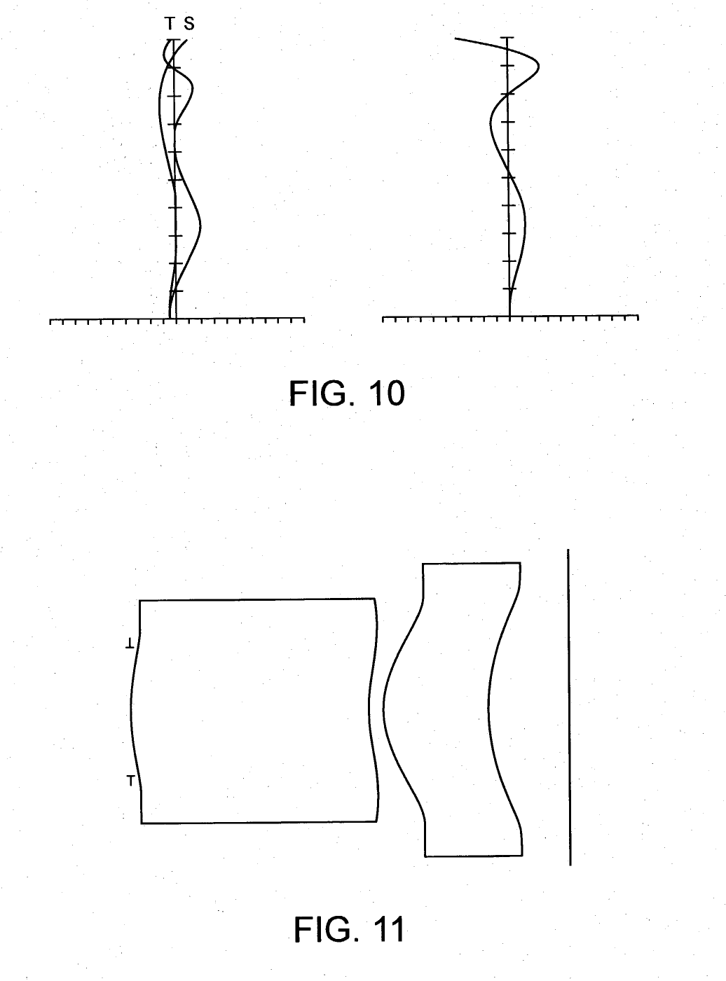

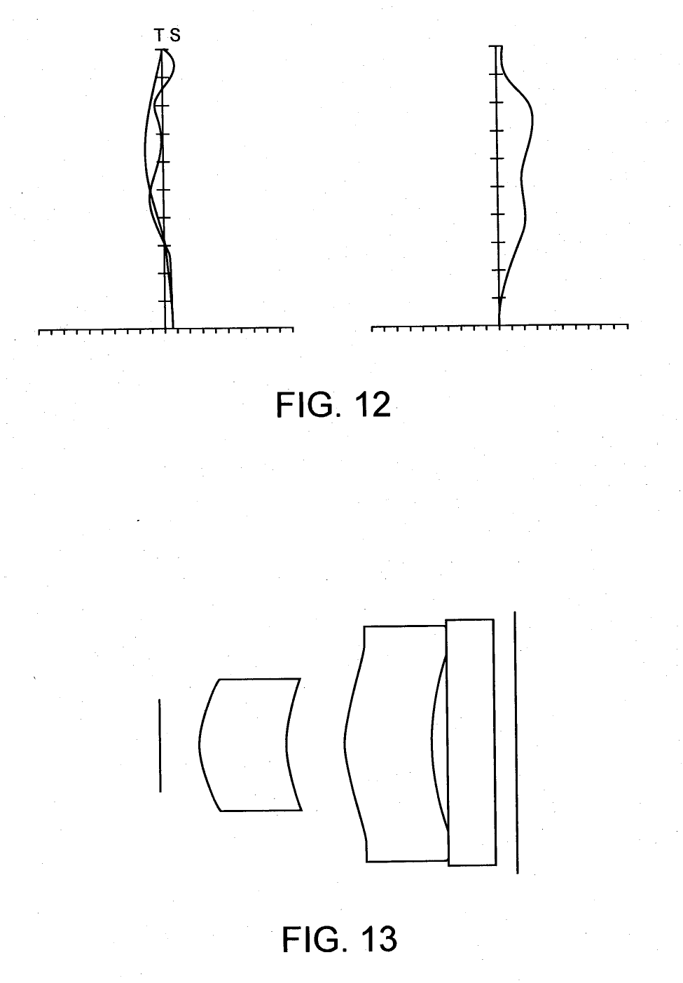

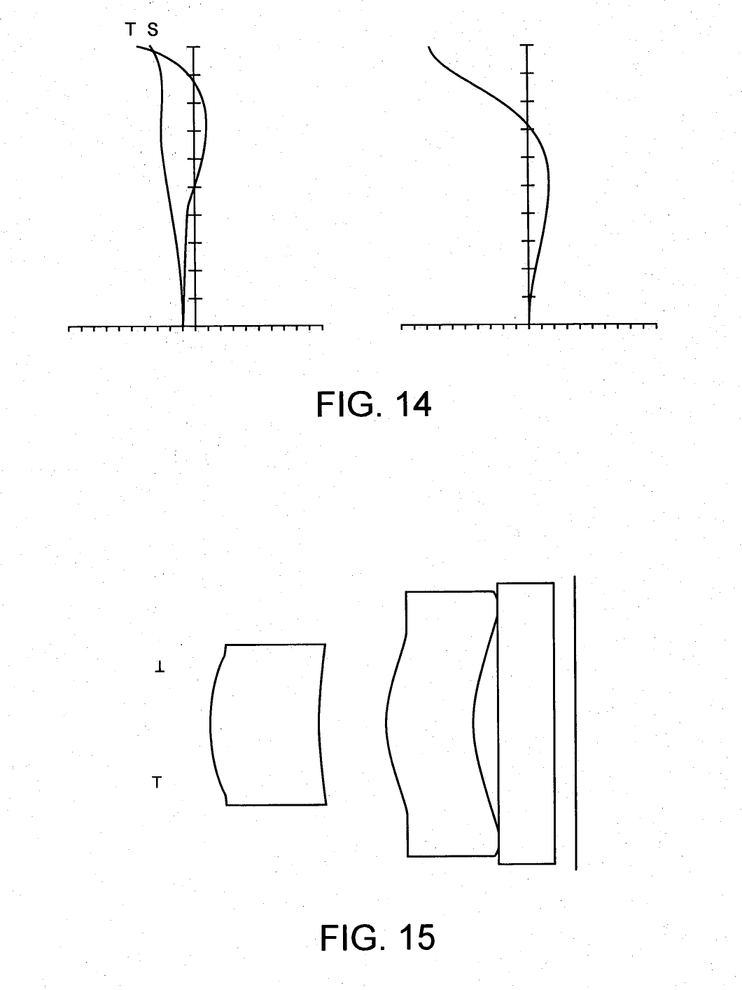

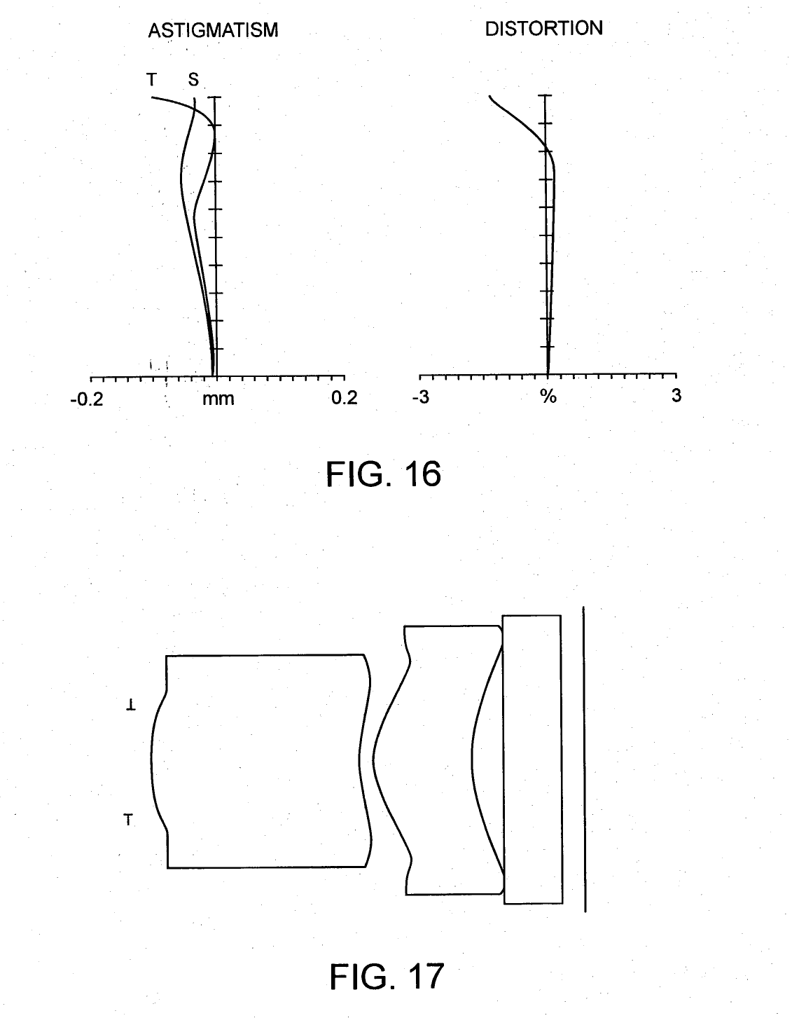

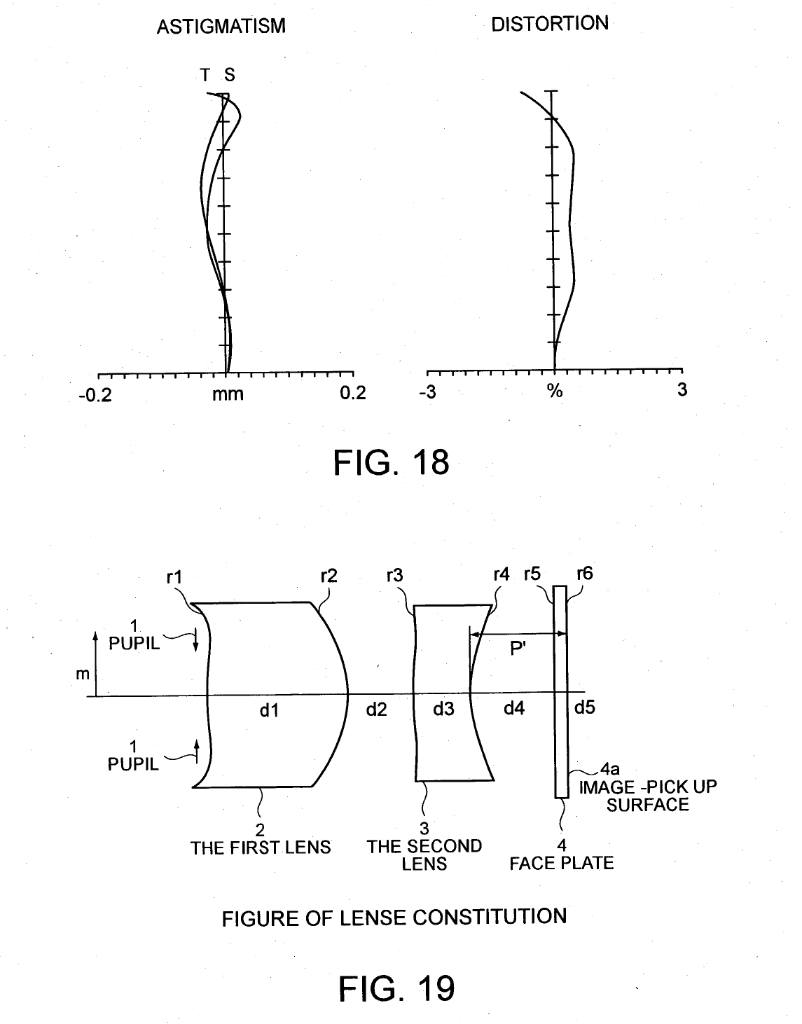

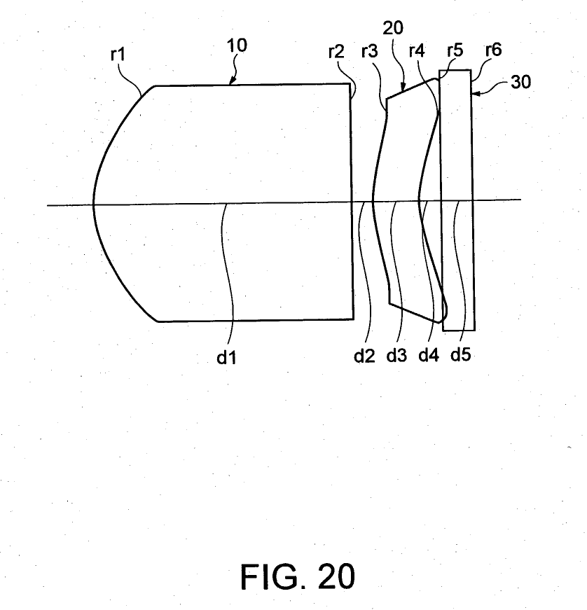

FIG. 1 is a sectional view of an image-pick up lens of the present invention. Light beams incident from the side of an object sequentially pass through an aperture stop 1 at the side closest to the object, a first meniscus lens 2 having a convex surface on the object side and a second meniscus lens 3 also having a convex surface on the object side so as to be converged on a light receiving surface of an image pickup device 5. Usually, a cover glass 4 is provided between the meniscus lens 3 and the image pickup device 5 but is not required.

Arranging the aperture stop 1 at the side closest to the object is a condition for narrowing down the angle of incidence onto the image pickup device 5. Each of the first and the second meniscus lenses has a convex surface on the object side and a concave surface on the image side. The convex surfaces. R1 and R3 of both lenses supply positive power. The convex surface R1 having positive power of the first lens 2 is arranged relatively close to the stop 1, such that the occurrence of chromatic aberration of magnification is restrained to a minimum. Moreover, a concave surface R2 on the image side, because of its concavity, exhibits relatively strong negative power to off-axis light beams passing through at the position higher than R1, thereby correcting the chromatic aberration of magnification.

Next described is another condition for narrowing down the angle of incidence onto the image pickup device 5, which is to satisfy:
0.2<f/f2<2.

This indicates burdening the second lens 3 with relatively strong power. This positive power is borne by R3 on the object side, and a concave surface is provided on the image side. Light beams passing through the surface having that positive power pass through at a relatively high position, which is a factor for generating largely off-axis aberrations such as distortion and astigmatism. Such aberrations are corrected by taking balance partially at the concave surfaces of the first lens 2 and the second lens 3 and also by having both surfaces of the second lens 3 aspheric. Moreover, the curvature radius R2 of the first lens 2 on the image side and the curvature radius R3 of the second lens on the object side are given a condition to satisfy:
0<R3/R2<0.9,
in order to keep the balance in an optimum range. At the same time, this condition is for restraining the occurrence of coma aberration. Furthermore, setting at least one surface of the first lens 2 to be aspheric increases the versatility of probable correction. Also, in order to take the above balance, it is desirable that the space between the first lens and the second lens satisfies a condition:
d2/f<0.4.

The fundamental constituents of the present invention have been described above. The meniscus lens 3 close to the image pickup device 5 can be substituted for the cover glass.

### EXAMPLES

The examples of the present invention are described below with particular numerical values.

TABLE 1
Lens Constituent Parameter

| | Curvature | | | | | | | |
|---|---|---|---|---|---|---|---|---|
| | Radius | | Space | | Refraction | | Dispersion | |
| Example 1 | | | d0 | 0.295 | | | | |
| 1 | R1 | 1.482 | d1 | 0.871 | n1 | 1.603 | u1 | 60.7 |
| 2 | R2 | 4.490 | d2 | 0.731 | n2 | | u2 | |
| 3 | R3 | 1.588 | d3 | 0.844 | n3 | 1.492 | u3 | 57.4 |
| 4 | R4 | 2.858 | d4 | 0.134 | n4 | | u4 | |
| 5 | R5 | | d5 | 0.500 | n5 | 1.492 | u5 | 57.4 |
| 6 | R6 | | d6 | 0.200 | n6 | | u6 | |
| Example 2 | | | d0 | 0.292 | | | | |
| 1 | R1 | 1.408 | d1 | 0.905 | n1 | 1.492 | u1 | 57.4 |
| 2 | R2 | 13.824 | d2 | 0.735 | n2 | | u2 | |
| 3 | R3 | 1.684 | d3 | 0.807 | n3 | 1.492 | u3 | 57.4 |
| 4 | R4 | 2.509 | d4 | 0.130 | n4 | | u4 | |
| 5 | R5 | | d5 | 0.500 | n5 | 1.492 | u5 | 57.4 |
| 6 | R6 | | d6 | 0.200 | n6 | | u6 | |
| Example 3 | | | d0 | 0.111 | | | | |
| 1 | R1 | 1.700 | d1 | 0.872 | n1 | 1.697 | u1 | 55.5 |
| 2 | R2 | 6.914 | d2 | 0.831 | n2 | | u2 | |
| 3 | R3 | 2.162 | d3 | 1.250 | n3 | 1.492 | u3 | 57.4 |
| 4 | R4 | 3.090 | d4 | 0.313 | n4 | | u4 | |
| Example 4 | | | d0 | 0.000 | | | | |
| 1 | R1 | 1.621 | d1 | 0.845 | n1 | 1.639 | u1 | 55.4 |
| 2 | R2 | 4.921 | d2 | 0.812 | n2 | | u2 | |
| 3 | R3 | 1.664 | d3 | 0.895 | n3 | 1.492 | u3 | 57.4 |
| 4 | R4 | 4.549 | d4 | 0.117 | n4 | | u4 | |
| 5 | R5 | | d5 | 0.500 | n5 | 1.492 | u5 | 57.4 |
| 6 | R6 | | d6 | 0.200 | n6 | | u6 | |
| Example 5 | | | d0 | 0.000 | | | | |
| 1 | R1 | 1.927 | d1 | 2.018 | n1 | 1.492 | u1 | 57.4 |
| 2 | R2 | 5.452 | d2 | 0.327 | n2 | | u2 | |
| 3 | R3 | 0.834 | d3 | 0.799 | n3 | 1.492 | u3 | 57.4 |
| 4 | R4 | 1.233 | d4 | 0.717 | n4 | | u4 | |

Table 1 is a list showing configurations of the examples 1 through 5. The numbers on the left edge of the table correspond to the respective surfaces of the lenses. 1 indicates the first surface of the first lens 2; 2 indicates the second surface of the first lens 2; 3 indicates the first surface of the second lens 3; and 4 indicates the second surface of the second lens 3. 5 or 6, if any, indicates cover glasses 4. Moreover, R stands for curvature radius; d for space; n for refraction; and u for dispersion.

Table 2 is a list showing aspheric coefficients of the same examples 1 through 5. The aspheric surface of the present invention employs the one shown by the first formula for convenience; however, it is not limited to this type.

$$\begin{matrix}z = \frac{{ch}^{2}}{1 + \sqrt{1 - ( 1 + k ) {c}^{2} {h}^{2}}} + \\ {A}_{4} {h}^{4} + {A}_{6} {h}^{6} + {A}_{8} {h}^{8} + ⋯ + {A}_{26} {h}^{26}\end{matrix} \qquad Formula 1$$

Here, ‘z’ in the formula 1 indicates the depth from the reference surface in the direction of an optical axis passing through the apex of the aspheric surface. Also, ‘c’ is the inverse number of the curvature radius R of the surface, and ‘h’ indicates the height from the optical axis of the surface. ‘k’ is a conic constant, and A₄ to A₂₆ are correction coefficients of the aspheric surfaces.

TABLE 2
Coefficients of Aspheric Surfaces

| | Conic Constant | A4 | A6 | A8 | A10 |
|---|---|---|---|---|---|
| Example 1 | | | | | |
| 1 | 0.324 | −1.84774E−02 | 1.87118E−02 | −2.38593E−01 | 4.85453E−01 |
| 2 | | | | | |
| 3 | −3.439 | −9.28269E−03 | −1.98441E−01 | 2.60480E−01 | −2.42182E−01 |
| 4 | | 6.25549E−02 | −9.58465E−02 | −1.42453E−02 | 3.82246E−03 |
| Example 2 | | | | | |
| 1 | | | | | |
| 2 | | | | | |
| 3 | −6.270 | −2.42102E−02 | −1.27847E−01 | 1.28955E−01 | −1.84828E−01 |
| 4 | 0.390 | 1.40284E−02 | −9.11446E−02 | −1.78719E−03 | −2.64845E−04 |
| Example 3 | | | | | |
| 1 | | | | | |
| 2 | | | | | |
| 3 | 2.126 | −1.42566E−01 | −3.59285E−01 | 6.99738E−01 | −5.46820E−01 |
| 4 | 2.591 | 5.81988E−02 | −1.23473E−01 | −2.55556E−02 | 1.54841E−02 |
| Example 4 | | | | | |
| 1 | | | | | |
| 2 | | | | | |
| 3 | −1.379 | −4.40821E−02 | −1.17332E−01 | 1.52895E−01 | −1.45221E−01 |
| 4 | −2.125 | 1.29928E−01 | −9.61265E−02 | −2.70686E−02 | 6.34898E−03 |
| Example 5 | | | | | |
| 1 | 0.182 | −8.12510E−02 | 1.06158E−01 | −8.69766E−02 | 1.86760E−02 |
| 2 | −63.085 | −1.19118E−01 | 3.94254E−01 | −6.04547E−01 | 4.27328E−01 |
| 3 | −4.297 | 6.90387E−02 | −2.13402E−01 | 1.23422E−01 | −7.26440E−02 |
| 4 | | −2.89576E−02 | −1.08058E−01 | 6.72151E−03 | 5.71139E−04 |

Similarly, table 3 is a list showing constituent parameters of Examples 6 through 9 of the present invention.

TABLE 3

| | Curvature | | | | | | | |
|---|---|---|---|---|---|---|---|---|
| | Radius | | Space | | Refraction | | Dispersion | |
| Example 6 | | | d0 | 0.000 | | | | |
| 1 | R1 | 1.646 | d1 | 2.005 | n1 | 1.492 | ν1 | 57.4 |
| 2 | R2 | 0.944 | d2 | 0.123 | n2 | | ν2 | |
| 3 | R3 | 0.565 | d3 | 0.878 | n3 | 1.492 | ν3 | 57.4 |
| 4 | R4 | 1.754 | d4 | 0.697 | n4 | | ν4 | |
| Example 7 | | | d0 | 0.393 | | | | |
| 1 | R1 | 1.048 | d1 | 0.868 | n1 | 1.492 | ν1 | 57.4 |
| 2 | R2 | 2.021 | d2 | 0.583 | n2 | | ν2 | |
| 3 | R3 | 1.461 | d3 | 0.877 | n3 | 1.492 | ν3 | 57.4 |
| 4 | R4 | 2.476 | d4 | 0.132 | n4 | | ν4 | |
| 5 | R5 | | d5 | 0.500 | n5 | 1.492 | ν5 | 57.4 |
| 6 | R6 | | d6 | 0.200 | n6 | | ν6 | |
| Example 8 | | | d0 | 0.474 | | | | |
| 1 | R1 | 1.331 | d1 | 0.996 | n1 | 1.492 | ν1 | 57.4 |
| 2 | R2 | 3.601 | d2 | 0.589 | n2 | | ν2 | |
| 3 | R3 | 1.128 | d3 | 0.787 | n3 | 1.492 | ν3 | 57.4 |
| 4 | R4 | 1.544 | d4 | 0.224 | n4 | | ν4 | |
| 5 | R5 | | d5 | 0.500 | n5 | 1.492 | ν5 | 57.4 |
| 6 | R6 | | d6 | 0.200 | n6 | | ν6 | |
| Example 9 | | | d0 | 0.201 | | | | |
| 1 | R1 | 1.614 | d1 | 1.790 | n1 | 1.492 | ν1 | 57 |
| 2 | R2 | 0.945 | d2 | 0.125 | n2 | | ν2 | |
| 3 | R3 | 0.575 | d3 | 0.853 | n3 | 1.492 | ν3 | 57.4 |
| 4 | R4 | 1.761 | d4 | 0.266 | n4 | | ν4 | |
| 5 | R5 | | d5 | 0.500 | n5 | 1.492 | ν5 | 57.4 |
| 6 | R6 | | d6 | 0.200 | n6 | | ν6 | |

Table 4 is a list showing coefficients of aspheric surfaces corresponding to the Examples 6 through 9 of the table 3.

TABLE 4

| | Conic Constant | A4 | A6 | A8 | A10 |
|---|---|---|---|---|---|
| Example 6 | | | | | |
| 1 | 4.458 | −1.71953E−01 | 1.65126E−02 | −6.61728E−01 | −6.59696E−02 |
| 2 | −17.729 | −3.78532E−01 | 4.64129E−01 | −3.53272E−01 | 1.18140E−01 |
| 3 | −4.387 | 2.30950E−01 | −4.88647E−01 | 3.35821E−01 | −1.26878E−01 |
| 4 | | 2.20536E−01 | −4.21015E−01 | 1.98603E−01 | −4.05513E−02 |
| Example 7 | | | | | |
| 1 | −11.868 | 1.04025E+00 | −2.57256E+00 | 4.90977E+00 | −3.89899E+00 |
| 2 | −25.556 | 2.57666E−01 | 2.95112E−01 | −8.66284E−01 | 1.79993E+00 |
| 3 | −6.579 | 3.32025E−02 | −9.96925E−02 | −3.62352E−02 | 5.97316E−02 |
| 4 | 1.065 | 1.24214E−02 | −1.01206E−01 | −1.65636E−02 | 1.78143E−02 |
| Example 8 | | | | | |
| 1 | 0.070 | −9.56421E−02 | 1.28859E−01 | −3.87546E−02 | −9.91222E−02 |
| 2 | −64.586 | −1.03992E−01 | 3.57275E−01 | −6.51344E−01 | 5.47411E−01 |
| 3 | −4.606 | 6.03460E−02 | −2.19360E−01 | 1.25817E−01 | −1.28318E−01 |
| 4 | | −2.95634E−02 | −1.14580E−01 | −4.46383E−03 | 5.28375E−03 |
| Example 9 | | | | | |
| 1 | 2.353 | −1.20185E−01 | 7.93709E−02 | −4.15463E−01 | 2.60302E−01 |
| 2 | −14.015 | −4.43154E−01 | 6.62412E−01 | −6.81107E−01 | 2.67644E−01 |
| 3 | −4.076 | 2.02457E−01 | −5.23692E−01 | 4.84453E−01 | −3.07503E−01 |
| 4 | | 2.32644E−01 | −4.35395E−01 | 1.92152E−01 | −3.96262E−02 |

Of the above Examples, in each of the Examples 1, 2, 4, 7, 8 and 9, the image-pick up lens includes the cover glass 4 on the image side thereof.

Table 5 is a list showing the relations between focal lengths and the respective parameters related to the Examples 1 through 10.

TABLE 5

| Example | 1 | 2 | 3 | 4 | 5 | 6 | 7 | 8 | 9 |
|---|---|---|---|---|---|---|---|---|---|
| Fno | 2.50 | 2.49 | 2.48 | 2.48 | 2.54 | 2.49 | 2.52 | 2.50 | 2.50 |
| Angle of Incidence | 29.29 | 29.29 | 29.28 | 29.30 | 29.31 | 29.31 | 29.28 | 29.29 | 29.31 |
| Angle of Emission | 18.39 | 20.00 | 7.48 | 15.68 | 20.00 | 20.00 | 20.00 | 20.00 | 20.00 |
| Focal Length f | 2.34 | 2.34 | 2.34 | 2.34 | 2.34 | 2.34 | 2.34 | 2.34 | 2.34 |
| f1 | 3.29 | 3.10 | 3.01 | 3.42 | 5.07 | −81.20 | 3.40 | 3.73 | −40.39 |
| f2 | 5.93 | 7.83 | 10.08 | 4.82 | 3.14 | 1.36 | 5.61 | 5.21 | 1.40 |
| f/f2 | 0.39 | 0.30 | 0.23 | 0.49 | 0.75 | 1.73 | 0.42 | 0.45 | 1.68 |
| Total Length T | 3.57 | 3.57 | 3.38 | 3.37 | 3.86 | 3.70 | 3.55 | 3.77 | 3.93 |
| T/f | 1.53 | 1.52 | 1.44 | 1.44 | 1.65 | 1.58 | 1.52 | 1.61 | 1.68 |
| Space between | 0.73 | 0.73 | 0.83 | 0.81 | 0.33 | 0.12 | 0.58 | 0.59 | 0.13 |
| Lenses d2 | | | | | | | | | |
| d2/f | 0.31 | 0.31 | 0.36 | 0.35 | 0.14 | 0.05 | 0.25 | 0.25 | 0.05 |
| R1 | 1.48 | 1.41 | 1.70 | 1.62 | 1.93 | 1.65 | 1.05 | 1.33 | 1.61 |
| R2 | 4.49 | 13.82 | 6.91 | 4.92 | 5.45 | 0.94 | 2.02 | 3.60 | 0.95 |
| R3 | 1.59 | 1.68 | 2.16 | 1.66 | 0.83 | 0.56 | 1.46 | 1.13 | 0.57 |
| R4 | 2.86 | 2.51 | 3.09 | 4.55 | 1.23 | 1.75 | 2.48 | 1.54 | 1.76 |
| R1/R2 | 0.33 | 0.10 | 0.25 | 0.33 | 0.35 | 1.74 | 0.52 | 0.37 | 1.71 |
| R3/R2 | 0.35 | 0.12 | 0.31 | 0.34 | 0.15 | 0.60 | 0.72 | 0.31 | 0.61 |
| R3/R4 | 0.56 | 0.67 | 0.70 | 0.37 | 0.68 | 0.32 | 0.59 | 0.73 | 0.33 |

The present invention enables a large angle of field just around 30° and realizes a low-cost image-pick up lens system of a small size which is particularly short in total length.

The entire disclosure of Japanese Patent Application No. 2002.-136255 filed May 10, 2002 is incorporated by reference.

1. An image-pick up lens comprising:
from a side of an object:
an aperture stop;
a first meniscus lens having a convex surface on the object side; and
a second meniscus lens having a convex surface on the object side,
wherein, when at least both surfaces of the second lens are aspheric; and ‘f’ indicates a focal length of all systems, ‘f2’ indicates a focal length of the second lens, ‘R2’ indicates a paraxial curvature radius of the first lens on a side of an image, and ‘R3’ indicates a paraxial curvature radius of the second lens on the object side:
0.2<f/f2<2 and 0<R3/R2<0.9.

2. The image-pick up lens described in claim 1, wherein at least one surface of the first meniscus lens is aspheric.

3. The image-pick up lens described in claim 1, when ‘f’ indicates a focal length of the image-pick up lens, ‘T’ indicates a length from the aperture stop to an image surface, ‘d2’ indicates a space between the first lens and the second lens:
d2/f<0.4 and T/f<2.
